(19) United States
(12) Patent Application Publication
(10) Pub. No.: US 2003/0038554 A1
(43) Pub. Date: Feb. 27, 2003

(54) Generator

(76) Inventor: Albert Sullivan, Gary, IN (US)

Correspondence Address: ALBERT SULLIVAN, 2101 WEST 19TH AVENUE, GARY, IN, 46404, US

(21) Appl. No.: 09/940,156

(22) Filed: Aug. 25, 2001

(51) Int. Cl. H02K 47/04

(52) U.S. Cl. 310/113

(57) ABSTRACT

The use of an electric motor to generate power.

### CROSS REFERENCE TO RELATED APPLICATIONS:

Not applicable

### STATEMENT REGARDING FEDERALLY SPONSORED RESEARCH OR DEVELOPMENT

No federal funds were used in the development of this product.

### REFERENCE TO A MICROFICHE APPENDIX

Not applicable

### BACKGROUND OF THE INVENTION

Environmental, power generation

### BRIEF SUMMARY OF THE INVENTION

Reduces carbon monoxide emissions.

### BRIEF DESCRIPTION OF THE SEVERAL VIEWS OF THE DRAWING

Not applicable

### DETAILED DESCRIPTION OF THE INVENTION

The invention uses an electrically driven motor. Previous generators use a gas motor.

### CLAIMS

See page number 2.

### ABSTRACT OF THE DISCLOSURE

See page number 3.

### DRAWINGS

Not applicable

### DECLARATION

See form PTO/SB/01 (Attached)

### SEQUENCE LISTING

Not applicable

1. “What I claim as my invention is the use of any electrically driven motor to generate power.”
